(19) United States
(12) Patent Application Publication
(10) Pub. No.: US 2026/0237401 A1
(43) Pub. Date: Aug. 13, 2026

(54) METHOD AND SYSTEM FOR ROBUST PROCESSING OF SPEECH CLASSIFIER

(71) Applicant: DOLBY LABORATORIES LICENSING CORPORATION

(72) Inventor: Lie LU, Dublin, CA (US)

(73) Assignee: DOLBY LABORATORIES LICENSING CORPORATION, (US)

(21) Appl. No.: 19/153,929

(22) PCT Filed: Feb. 2, 2024
(86) PCT No.: PCT/US2024/014225

§ 371 Date: Aug. 5, 2025

Related U.S. Application Data
(60) Provisional application No. 63/483,584, filed on Feb. 7, 2023.
(60) Provisional application No. 63/592,686, filed on Oct. 24, 2023.

(51) Int. Cl. G10L 25/78; G10L 15/08

(52) U.S. Cl. CPC G10L 25/78; G10L 15/08; G10L 2025/786

(57) ABSTRACT

The present disclosure relates to a method and system for performing speech classification for an audio signal. The method comprises obtaining the audio signal comprising a sequence of audio frames and determining, for each audio frame, a first speech confidence metric using a first speech classifier. For each given audio frame of at least a subset of the sequence of audio frames the method comprises classifying each respective audio frame of a first context window associated with the given audio frame as a speech-frame or non-speech frame by comparing the first speech confidence metric of the respective audio frame to a first predetermined threshold, determining an adaptive threshold based on the number of speech frames of the first context window and determining a first binary speech classification indicator for the given audio frame based on the first speech confidence metric and the adaptive threshold.

### CROSS-REFERENCE TO RELATED APPLICATIONS

This application claims priority to U.S. Provisional Patent Application No. 63/483,584 filed Feb. 7, 2023 and U.S. Provisional Patent Application No. 63/592,686 filed Oct. 24, 2023, each of which are incorporated by reference in their entireties.

### TECHNICAL FIELD

The present disclosure relates to a method and a system for performing speech classification of an audio signal.

### BACKGROUND

For many types of audio processing, a dialogue or speech classifier is used to identify the presence of dialogue or speech in an audio signal. For example, in Dialogue Enhancement (DE) it is often very useful to extract a dialogue classifier indicating at which points in time dialogue is active in the audio signal to e.g. control when different types of dialogue enhancement processing should be applied.

There exist many different types of dialogue classifiers. Recently many dialogue classifiers based on neural networks have been proposed. Neural network based dialogue classifiers, as well as other types of dialogue classifiers, typically predict a dialogue confidence (typically a value between zero and one) indicating the likelihood of dialogue being present in each frame of an audio signal. By comparing the dialogue confidence to a predetermined threshold, typically 0.5, a classification in the form of a predicted binary dialogue label may be obtained indicating for each frame if it is “true” or “false” that dialogue is present.

During training of the dialogue classifier, a large set of training frames are provided to the dialogue classifier which predicts, for each frame, a dialogue confidence. A loss (such as binary cross-entropy loss) is then computed by comparing the dialogue confidence and a ground truth dialogue label. The learnable parameters of the dialogue classifier are updated to minimize the average loss until the training converges.

The trained classifier can then be used in a large variety of applications where it is useful to know when dialogue is present in an audio signal. For instance, a simple dialogue separator can be realized by applying a gating function to an audio signal based on the predicted dialogue label. The gating function may e.g. be configured to silence or attenuate the audio signal when the dialogue label indicates that dialogue is not present, leaving a processed audio signal with isolated dialogue.

### SUMMARY

A drawback with existing speech classifiers is that the misclassification of frames depends strongly on the type of audio content. For example, music content has proven especially challenging since speech classifiers tend to classify certain types of music as speech, leading to many false positives. It is therefore a purpose of the present disclosure to provide an improved method for classifying speech which is accurate and works for a large variety of different audio content types.

According to a first aspect of the disclosure there is provided a method for performing speech classification for an audio signal comprising obtaining the audio signal comprising a sequence of audio frames; determining, for each audio frame, a first speech confidence metric using a first speech classifier, the first speech confidence metric indicating a likelihood of speech being present in the audio frame. The method further comprises, for each given audio frame of at least a subset of the sequence of audio frames, classifying each respective audio frame of a first context window associated with the given audio frame as a speech-frame or non-speech frame by comparing the first speech confidence metric of the respective audio frame to a first predetermined threshold, determining an adaptive threshold based on the number of speech frames of the first context window, and determining a first binary speech classification indicator for the given audio frame based on the first speech confidence metric and the adaptive threshold.

With the term “speech” it is meant any type of conversational vocal communication, such as speech of a single voice (monologue), speech of two voices (dialogue) or many voices. The term “speech” does however not include singing voice since singing voice often is classified as music content rather than speech content. However, since both singing voice and speech are human utterances it is often difficult for speech classifiers to distinguish the two from each other. Oftentimes, a speech classifier will produce many false positives for music content with a singing voice, by falsely classifying the singing voice as speech.

With an adaptive threshold which is based on the number of speech frames in the first context window the threshold for determining if speech is present or not may be adjusted on a frame by frame basis based on the context of each frame. The adaptive threshold results in improved classification accuracy for many types of audio content including improvements in reduced false positives for music content with singing voices.

By comparison, using a fixed threshold of 0.5 for binarizing the speech confidence an equal false-negative error rate for speech label prediction can be achieved. That is, the false negative rate (i.e. speech falsely classified as non-speech) is approximately equal to the false positive rate (i.e. non-speech falsely classified as speech). An equal false-negative error rate provides a well-balanced and all-around speech classifier that can be used for many types of audio content. However, for some applications, it may be more important that no speech content is missed than that non-speech content is correctly classified (i.e. as non-speech content). This may be achieved by using a lower threshold of, for example, 0.2, or even 0.1, thus labelling more frames as speech content. While a lower threshold decreases the false negatives the false positives increase. A low threshold has been found to work well for movie content or sports audio content but if the same low threshold is used for music content the increased false positives may introduce level pumping and/or signal instability after processing.

With the adaptive threshold of the present disclosure the threshold is adjusted based on the number of speech frames detected in the first context window which enables a low error rate to be achieved for a larger variety of audio content types, including sports audio content, movie audio content and music.

According to some implementations, determining a first binary speech classification indicator comprises binarizing the first speech confidence metric with the adaptive threshold.

With the term “binarizing” it is meant converting a numerical value in a range (e.g. a continuous range, for instance from 0 to 1) to a binary Boolean having two states. Binarization is performed by comparing the numerical value with a threshold wherein if the numerical value is above the threshold the Boolean assumes the first state (the true, T, state) and if the numerical value is below the threshold the Boolean assumes the second state (the false, F, state). In situations when the numerical value equals the threshold the Boolean may assume either the first state or the second state. Accordingly, it is understood that the binarization process may be configured such that the Boolean assumes the first state if the numerical value is above or equal to the threshold or configured such that the Boolean assumes the second state if the numerical value is below or equal to the threshold. Accordingly, the first binary speech classification indicator is obtained by binarization using an adaptive threshold that is updated and changes on a frame-by-frame basis.

According to some implementations the method further comprises determining, for each audio frame, a second speech confidence metric using a second speech classifier different from the speech classifier, the second speech confidence metric indicating a likelihood of speech being present in the frame. The method further comprises, for each given audio frame of the subset of the sequence of audio frames: classifying each respective audio frame of a second context window associated with the given audio frame as a speech-frame or non-speech frame by comparing the second speech confidence metric of the respective frame to a second predetermined threshold, and (a) determining a second adaptive threshold based on the number of speech frames in the second context window and/or the number of frames in the first context window, and determining an enhanced binary speech classification indicator for the given audio frame based on the adaptive threshold and the second adaptive threshold, or (b) wherein the adaptive threshold is based on the number of speech frames in the first context window and the number of speech frames in the second context window.

That is, the capabilities of two different speech classifiers can be combined to form an even more accurate binary speech classification indicator. The number of speech frames in each context window is combined to determine more accurate a single adaptive threshold or the number of speech frames of each context window is used to form a respective (first and second) adaptive threshold whereby both thresholds are used to determine an enhanced binary classification indicator. Both approaches improve classification accuracy and can be used separately or combined.

According to a second aspect of the disclosure there is provided a computer program product comprising instructions which, when the program is executed by a computer, causes the computer to carry out the method of the first aspect of the disclosure.

According to a third aspect of the disclosure there is provided a system comprising one or more processors configured to carry out the method of the first aspect of the disclosure.

The disclosure according to the second and third aspect features the same or equivalent benefits as the disclosure according to the first aspect. Any functions described in relation to a method, may have corresponding features in a system or a computer program product.

### DESCRIPTION OF THE DRAWINGS

Aspects of the present disclosure will be described in more detail with reference to the appended drawings, showing exemplary embodiments.

FIG. 1 is a block diagram showing a speech separation system that uses a speech classification system according to some implementations.

FIG. 2 is a block diagram showing a speech classification system implementing an adaptive threshold according to some implementations.

FIG. 3 is a flow diagram outlining a method for determining a binary speech classification metric with an adaptive threshold according to some implementations.

FIG. 4 is a block diagram illustrating a variable threshold applicator according to some implementations.

FIG. 5 is a graph showing exemplary threshold functions for determining the adaptive threshold based on a speech ratio.

FIG. 6 is a block diagram showing a speech classification system 10 comprising two speech classifiers according to some implementations.

FIG. 7 is a block diagram showing a second variable threshold applicator that optionally obtains information from a first variable threshold applicator according to some implementations.

FIG. 8 is a graph showing a scaling function for determining a modified speech ratio according to some implementations.

FIG. 9 is a graph showing an exemplary function for setting the parameter u based on the relationship between the first and second speech ratio.

### DETAILED DESCRIPTION

Systems and methods disclosed in the present application may be implemented as software, firmware, hardware or a combination thereof. In a hardware implementation, the division of tasks does not necessarily correspond to the division into physical units; to the contrary, one physical component may have multiple functionalities, and one task may be carried out by several physical components in cooperation.

The computer hardware may for example be a server computer, a client computer, a personal computer (PC), a tablet PC, a set-top box (STB), a personal digital assistant (PDA), a cellular telephone, a smartphone, an AR/VR wearable, automotive infotainment system, a web appliance, a network router, switch or bridge, or any machine capable of executing instructions (sequential or otherwise) that specify actions to be taken by that computer hardware. Further, the present disclosure shall relate to any collection of computer hardware that individually or jointly execute instructions to perform any one or more of the concepts discussed herein.

Certain or all components may be implemented by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system (e.g., computer hardware) that includes one or more processors. Each processor may include one or more of a CPU, a graphics processing unit, and a programmable DSP unit. The processing system further may include a memory subsystem including a hard drive, SSD, RAM and/or ROM. A bus subsystem may be included for communicating between the components. The software may reside in the memory subsystem and/or within the processor during execution thereof by the computer system.

The one or more processors may operate as a standalone device or may be connected, e.g., networked to other processor(s). Such a network may be built on various different network protocols, and may be the Internet, a Wide Area Network (WAN), a Local Area Network (LAN), or any combination thereof.

The software may be distributed on computer readable media, which may comprise computer storage media (or non-transitory media) and communication media (or transitory media). As is well known to a person skilled in the art, the term computer storage media includes both volatile and non-volatile, removable and non-removable media implemented in any method or technology for storage of information such as computer readable instructions, data structures, program modules or other data. Computer storage media includes, but is not limited to, physical (non-transitory) storage media in various forms, such as EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by a computer. Further, it is well known to the skilled person that communication media (transitory) typically embodies computer readable instructions, data structures, program modules or other data in a modulated data signal such as a carrier wave or other transport mechanism and includes any information delivery media.

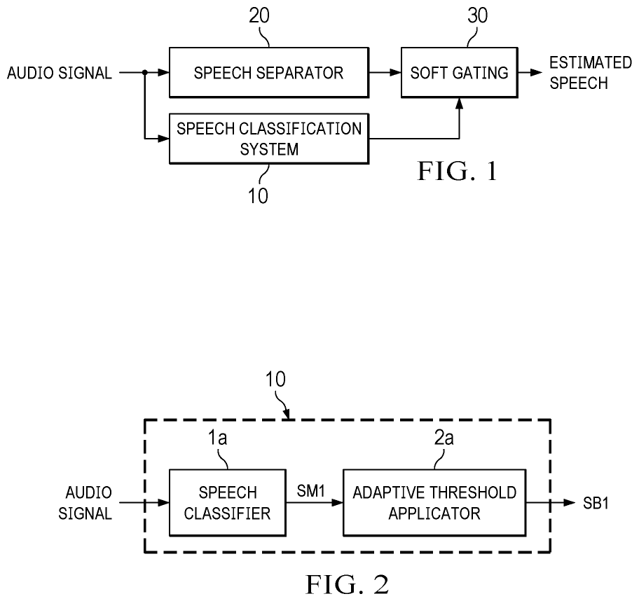

FIG. 1 shows an exemplary audio processing system 1 that uses a speech classification system 10 to separate speech content from an audio signal. The audio signal is provided to a speech separator 20 that processes the audio signal to obtain speech content. The speech separator 20 may be a neural network-based speech separator or any other type of speech separator 20. In a basic non-neural network implementation, the speech separator 20 is a bandpass filter configured to allow typical speech frequencies to pass while other frequencies are attenuated or stopped completely. An example of typical speech frequencies is between 150 Hz to 8 kHz, with female speech typically extending from 350 Hz to 8 kHz and male speech typically extending from 150 Hz to 6 kHz. More narrow frequency bands can also be used to capture the most important speech frequencies for maintain intelligibility, such as a frequency band from 300 Hz to 3.4 kHz. The output of the speech separator 20 is provided to a soft gating unit 30 which is controlled by the speech classification system 10.

The speech classification system 10 is configured to determine whether the audio signal comprises speech content. Typically, the speech classification system 10 determines a binary speech classification indicator for each frame of the audio signal wherein the binary speech classification indicator has a high value (a true state, T) and a low value (a false state, F) indicating if speech is present in the frame. That is, the speech classification system 10 will determine for each frame if it is to be classified as a speech frame or a non-speech frame.

The soft gating unit 30 is configured to allow output of the speech separator 20 (i.e. isolated speech) to pass through the soft gating unit 30 for speech frames and to suppress the output of the speech separator 20 from passing the soft gating unit 30 for non-speech frames. For example, since the speech separator 20 is not perfect it will allow some residual non-speech audio content to pass at times when no speech is present, the soft gating unit 30 will act as a further filter for suppressing this residual non-speech content by not allowing the content of non-speech frames to pass through the soft gating unit 30.

In some implementations, the soft gating unit 30 is configured to apply a 0 dB gain when speech is present in a frame and to apply a lower gain (e.g. −25 dB) when speech is not present in a frame. Optionally, the gating unit 30 completely silences the output audio signal from the speech separator 20 when speech is not present in a frame. To make the transition between speech and non-speech parts less abrupt, the soft gating unit 30 may implement finite transition times for the applied gains, such that the gain applied for non-speech frames smoothly transitions to the gain applied for speech frames and vice versa. While the soft gating unit 30 is controlled by a binary speech classification indicator it may be configured to apply a continuously varying gating, e.g. by smoothing the binary speech classification indicator.

The estimated speech audio signal outputted by the soft gating unit 30 may therefore be a cleaner speech signal with enhanced intelligibility compared to the output of the speech separator 20.

However, the function of the soft gating unit 30 (and the resulting speech isolation level in the outputted estimated speech audio signal) is limited by the accuracy of the speech classifier 10 and there is a need for a speech classification system 10 which is accurate for many types of audio content (e.g. accurate for music content as well as sport or movie content). Additionally, it is understood that speech classification systems 10 have many uses and can be, and currently are, implemented in many applications. For example, in addition to the speech separation audio processing system shown in FIG. 1, a speech classification system 10 can be used to label audio data for neural network training, alter audio rendering or audio processing techniques depending on the presence of speech, control noise suppression algorithms in e.g. tele- or video-conferencing applications etc. Accordingly, a new and improved speech classification system 10 can be used in many implementations.

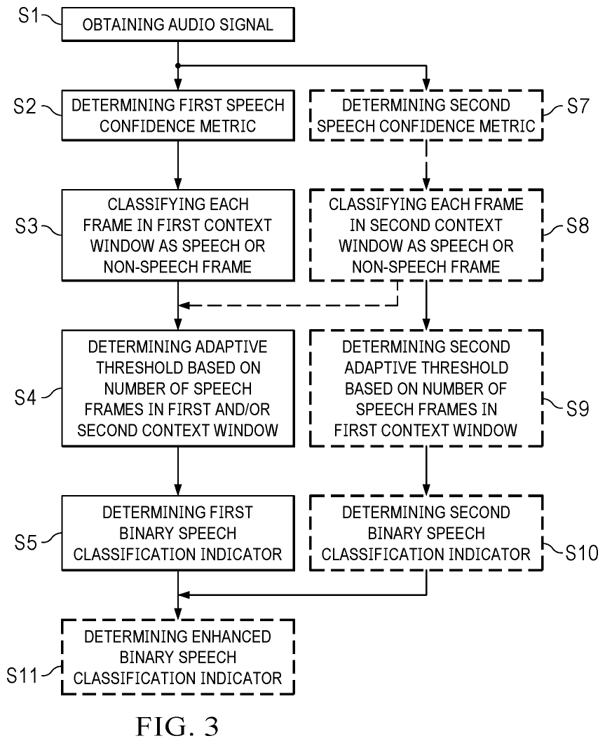

FIG. 2 is a block diagram detailing an example implementation of a speech classification system 10 for determining a binary speech classification indicator SB1. With further reference to the flowchart in FIG. 3, the operation of the speech classification system 10 will now be described in detail.

At step S1 the speech classification system 10 obtains an input audio signal. The speech classification system 10 comprises a first speech classifier 1a configured to determine at step S2, for each frame of the audio signal, a first speech confidence metric SM1, indicating the likelihood of speech being present in the audio frame. The first speech classifier 1a may be any type of speech classifier configured to determine, for each frame, a first speech confidence metric SM1. For example, the first speech classifier 1a may be based on a trained neural network.

The first speech confidence metric SM1 determined at step S2 is usually a value defined on the range [0, 1] with zero indicating a likelihood of 0% of speech being present in the audio frame, one indicating a likelihood of 100% of the speech being present and values between zero and one indicating a likelihood between 0% and 100%. Of course, the first speech confidence metric SM1 may be defined differently, for example on a range of [−1, 1] or [0, 100]. In the following, it will be assumed that the first speech confidence metric SM1 is defined on the range [0, 1] but the person skilled in the art will appreciate that this is merely exemplary and that the speech classifications system 10 can be implemented in a similar fashion with a first speech confidence metric SM1 defined differently.

The first speech confidence metric SM1 of each frame is provided to the adaptive threshold applicator 2a which firstly determines a first adaptive threshold to which the first speech confidence metric SM1 should be compared and secondly applies the adaptive threshold by binarizing the first speech confidence metric SM1 with (i.e. using) the first adaptive threshold.

The adaptive threshold application 2a determines the first adaptive threshold on a frame-by-frame basis by analyzing the frames of a context window associated with each frame.

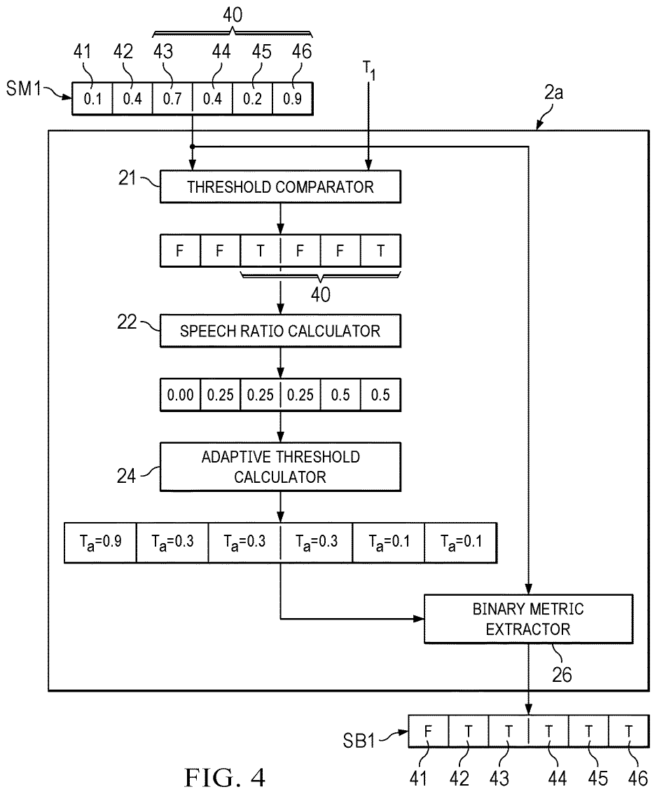

With further reference to FIG. 4 the operation of the adaptive threshold applicator 2a will now be described in further detail.

The first speech confidence metrics SM1 of the respective frames 41-46 are provided to the threshold applicator 2a. As seen in FIG. 4, the temporally earliest frame 41 has a first speech confidence metric SM1 of 0.1, subsequent frame 42 has a first speech confidence metric SM1 of 0.4, subsequent frame 43 has a first speech confidence metric SM1 of 0.7, subsequent frame 44 has a first speech confidence metric SM1 of 0.4, subsequent frame 45 has a first speech confidence metric SM1 of 0.2, and subsequent frame 46 has a first speech confidence metric SM1 of 0.9. The first speech confidence metric SM1 of each frame is provided to a threshold comparator 21 which binarizes each first speech confidence metric SM1 at step S3 by comparing each first speech confidence metric SM1 to a predetermined first threshold T₁. In the shown example the predetermined first threshold T₁ is equal to 0.5 which is a typical value (although other values are possible). For example, the first predetermined threshold T₁ may be between 0.1 and 0.6, such as about 0.5 or about 0.3. If the first speech confidence metric SM1 exceeds the first predetermined threshold T₁, the frame is classified as a speech frame (represented with a true, T, e.g. binary value 1) otherwise the frame is classified as a non-speech frame (represented with a false, F, e.g. binary value 0). In the shown example, frame 46 has a first speech confidence metric SM1 of 0.9 which exceeds the first predetermined threshold, whereby frame 46 is designated as a speech frame (indicated with the true state, T).

The binary speech/non-speech classification results are provided to a speech ratio calculator 22 which determines the number of frames NoF₁ classified as speech frames in a first context window 40 associated with each given frame. The first context window 40 for each given frame may comprise one or more of: (A) one or more frames preceding a given frame, (B) one or more frames succeeding the given frame and (C) the given frame itself. The first context window 40 may comprise a number of frames that together capture a temporal context of at least 5 seconds, at least 10 seconds, at least 20 seconds or at least 30 seconds. That is, each (given) frame can be said to be associated with its own respective first context window wherein the respective first context window comprises at least one of: one or more earlier frames and one or more later frames and optionally also the frame itself. While the same type of first context window (in terms of window length and number of earlier/later frames) may be used for each frame, the set of frames included in the first context window of a first frame will differ from the set of frames included in the first context window of a second frame.

As an illustrative example, the first context window 40 associated with the given frame 45 comprises the given frame 45, two preceding frames 43, 44 and one successive frame 46. This exemplary context window 40 thereby comprises a total of four frames including the given frame 45 for a total context window length W₁ of four frames. The context window 40 is then moved such that subsequent frame 46 takes the role of the given frame and so on.

The above mentioned exemplary context window is merely one example and it is understood that many different types of context windows can be used. In some implementations, a context window having a context window length exceeding ten, one hundred or even one thousand frames may be used. For example, a context window with 235 frames (representing about 5 seconds of content) or 1407 frames (representing about 30 seconds of content) may be used.

Many types of context window sizes can be used with one or more look-back frames and/or one or more look-ahead frames being included. While the given frame often is included in the exemplary first context window 40 shown in FIG. 4 it is also possible to define a context window comprising e.g. a number of (such as three) look-back frames preceding the given frame but not the given frame itself.

In FIG. 4 the exemplary context window comprising the given frame, two look-back frames and one look-ahead frame is used. The speech ratio calculator 22 counts the number of speech frames NoF₁ in this context window and finds zero, one, one, one, two and two speech frames as the given frame is frame 41, 42, 43, 44, 45, 46 respectively (assuming any frames preceding fame 41 are non-speech, F, frames and any frames succeeding frame 46 are speech, T, frames). Accordingly, each frame is associated with a Number-of-speech-frames NoF₁ value indicating the number of speech frames in the first context window 40 for that particular frame.

Optionally, the speech ratio calculator 22 determines a speech ratio r₁ for each frame being ratio between NoF₁ and the total number of frames in the context window 40 (i.e. the frame length W₁). In the current example, there are four frames in the context window 40 giving a speech ratio of 0.00, 0.25, 0.25, 0.25, 0.50 and 0.50 respectively, for frames 41, 42, 43, 44, 45, 46.

It is understood that for the illustrative example with context windows being only four frames long the speech ratio r₁ and NoF₁ can assume one of five possible values, i.e. 0, 0.25, 0.5, 0.75 and 1 for the speech ratio r₁. In many implementations the context window length is much longer, having at least ten, at least one hundred, or at least one thousand frames whereby many more values for r₁/NoF₁ are possible and r₁/NoF₁ may vary more smoothly for one frame to the next frame.

The NoF₁ value, or speech ratio r₁, is provided to an adaptive threshold calculator 24 which calculates and adaptive threshold Tₐ₁ for each frame 41-46 at step S4. The adaptive threshold Tₐ₁ is updated on a frame-to-frame basis and may for example be determined using a threshold function f(NoF) or f(r). The adaptive threshold Tₐ₁ for each frame is then provided to a binary metric extractor 26 which binarizes the first speech confidence metric SM1 of each frame with the adaptive threshold Tₐ₁ of each frame to obtain a binary speech classification indicator SB1 at step S5. By comparing the exemplary binary speech classification indicator SB1 with the speech/non-speech classification performed by the threshold comparator 21, it is seen that the classification results differ, and it has been found that with the adaptive threshold classification lower false positive levels for many types of audio content can be achieved. The first binary speech classification indicator SB1 can be used as the output of the speech classification system 10.

In some implementations, the adaptive threshold calculator 25 determines the adaptive threshold based on the NoF₁ or speech ratio r₁ using a threshold function f(NoF₁) mapping the number of speech frames NoF₁ to an adaptive threshold Tₐ or using a threshold function f(r₁) mapping the speech ratio r₁ to an adaptive threshold Tₐ₁. There are many exemplary functions f(NoF₁) or f(r₁) that can be used and in some implementations the threshold function f(NoF₁) or f(r₁) is a monotonically decreasing function for increasing number of speech frames NoF₁ (increasing speech ratio r₁) in the first context window 40. The term “monotonically decreasing” is meant to cover both monotonically non-increasing functions as well as the stronger requirement of monotonically strictly decreasing functions. That is, the threshold function f(·) is monotonically non-increasing if it fulfills f(x)>f(y) where y≥x and strictly monotonically decreasing if it fulfills f(x)>f(y) where y>x.

Some examples of threshold functions f(r₁) will now be presented but it is understood that these are merely exemplary and that other functions can be used. It is further understood that these functions can be converted to functions of the form f(NoF₁) if r₁ is replaced with NoF₁/W₁ where W₁ is the total number of frames in the first context window 40.

As a first exemplary threshold function (example A), a sigmoid function is used:

$${f}_{A} ( {r}_{1} ) = \frac{0.85}{1 + exp ( 15 ( {r}_{1} - 0.18 ) )} + 0 \text{.08} . \qquad ( eq . 1 )$$

As a second exemplary threshold function (example B), a linear approximation of the sigmoid function in equation 1 is used:

$${g}_{B} ( {r}_{1} ) = 0.5 + 2 ( 0.18 - {r}_{1} ) \qquad ( eq . 2 )$$

$${f}_{B} ( {r}_{1} ) = max ( {g}_{B} ( {r}_{1} ) , 0.1 ) .$$

As a third exemplary threshold function (example C), a linear approximation of equation 1 with an upper cap is used:

$${g}_{C} ( {r}_{1} ) = 0.5 + 2 ( 0.2 - {r}_{1} ) \qquad ( eq . 3 )$$

$${f}_{C} ( {r}_{1} ) = min ( max ( {g}_{C} ( {r}_{1} ) , 0.1 ) , 0.6 ) .$$

As a fourth exemplary threshold function (example D), the linear approximation of equation 3 is left-shifted to obtain a threshold function that generates smaller thresholds to recall more speech:

$${g}_{D} ( {r}_{1} ) = 0.2 + 2 ( 0.2 - {r}_{1} ) \qquad ( eq . 4 )$$

$${f}_{D} ( {r}_{1} ) = min ( max ( {g}_{D} ( {r}_{1} ) , 0.1 ) , 0.6 ) .$$

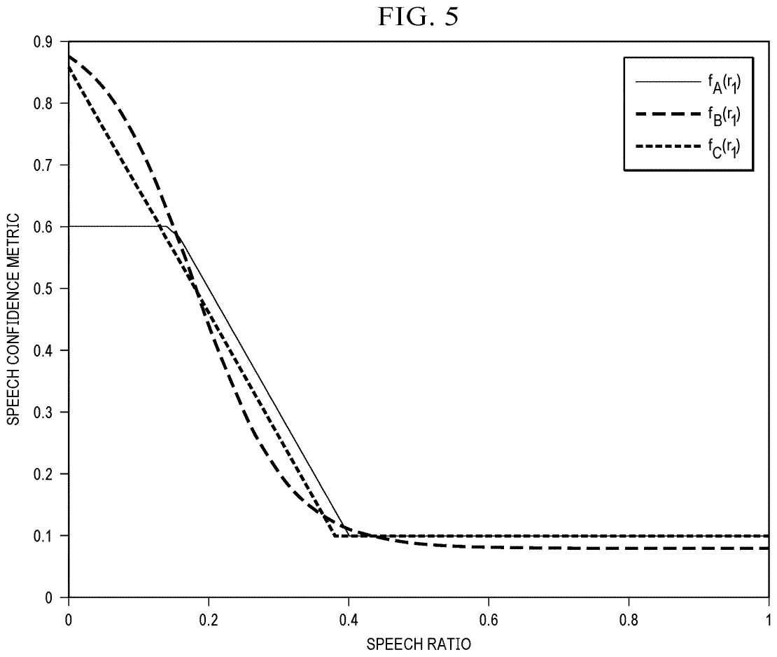

Functions f_{A}(r₁), f_{B}(r₁) and f_{C}(r₁) are shown in FIG. 5 for speech ratios r₁ ranging from zero (none of the frames in the context window 40 are speech frames) to one (all of the frames in the context window 40 are speech frames).

Any one of the above exemplary functions f_{A}(r₁), f_{B}(r₁), f_{C}(r₁) can be implemented by the adaptive threshold calculator 24 to determine the adaptive threshold at step S4 for each frame and the adaptive threshold results in lower false negatives for music and/or speech content.

In Table I the resulting error rate (expressed in percent) for music content and speech/movie content for a traditional speech classifier that compares the first speech confidence metric SM1 with a static threshold T of T=0.1 or T=0.5 and is compared to the improved speech classifier system 10 which uses the adaptive threshold extracted using thresholds functions A-D for different context window lengths (here expressed in temporal duration measured in seconds instead of number of frames). Table 1 highlights a drawback with using a predetermined static threshold T for making the final binarization of the first speech confidence metric SM1, namely if a higher static threshold (e.g. T=0.5) is used the false positive (FP) rate for music is rather low (1.62%) but the false negative (FN) rate for speech/movie content is high (3.31%) meaning that much speech content is misclassified as non-speech for speech/movie content. On the other hand, if a lower static threshold (e.g. 0.1) is used the FN rate for speech/movie content is improved (0.83%) such that much less speech content is missed. However, with the lower static threshold the FP rate for music increases instead (to 4.89%) meaning that much music content is misclassified as speech.

With the adaptive threshold based speech classification system 10 the speech classification results obtained offer lower FP rates for music content compared to the low static threshold T and lower FN rate for speech/movie content compared to the high static threshold. As an example, with function C and 30 second context window the FP rate for music is 1.71% whereas the FN and FP rates for speech/movie content are 1.30% and 6.44% respectively. Accordingly, the adaptive threshold processing provides a speech classification that achieves good performance in terms of both low FP rates for music and low FN rates for speech/movie content meaning that it performs well for both music and speech whereas a static threshold performs exceptionally well for only one type of audio content and poorly for the other type. While the FP rates for the speech/movie content still remain relatively high, it is still an improvement over processing with the low static threshold (wherein T=0.1) and, additionally, false positives for speech/movie content are in general much less noticeable and disruptive for listeners compared to false negatives for speech/movie content or false positives for music content.

TABLE I

| | | Music test set | Speech/movie test set | |
|---|---|---|---|---|
| | | FP [%] | FN [%] | FP [%] |
| Ref | Threshold = 0.5 | 1.62 | 3.31 | 2.19 |
| | Threshold = 0.1 | 4.89 | 0.83 | 8.12 |
| 30 s win | Function A | 1.57 | 1.21 | 7.01 |
| | Function B | 1.57 | 1.28 | 6.50 |
| | Function C | 1.71 | 1.30 | 6.44 |
| | Function D | 2.41 | 0.98 | 7.17 |
| 20 s win | Function A | 1.63 | 1.25 | 6.93 |
| | Function B | 1.63 | 1.32 | 6.42 |
| | Function C | 1.74 | 1.35 | 6.35 |
| | Function D | 2.46 | 1.00 | 7.14 |
| 10 s win | Function A | 1.78 | 1.30 | 6.82 |
| | Function B | 1.77 | 1.37 | 6.34 |
| | Function C | 1.82 | 1.40 | 6.28 |
| | Function D | 2.55 | 1.03 | 7.08 |
| 5 s win | Function A | 1.90 | 1.38 | 6.66 |
| | Function B | 1.89 | 1.44 | 6.21 |
| | Function C | 1.91 | 1.48 | 6.13 |
| | Function D | 2.56 | 1.07 | 6.95 |

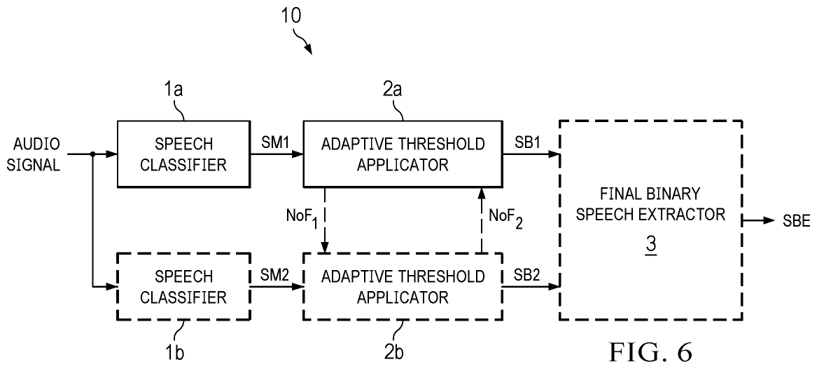

Turning to FIG. 6 it is shown that the speech classification system 10 according to some implementations can incorporate a second speech classifier 1b, that assists the first speech classifier 1a, wherein the second speech classifier 1b is different from the first speech classifier 1a. By combining two different speech classifiers 1a, 1b the strengths of each classifier 1a, 1b can be leveraged to achieve an even more accurate binary speech classification indicator SB1 or an enhanced binary speech classification indicator SBE as will be described below.

For example, the two speech classifiers 1a, 1b may be neural network based speech classifiers 1a. 1b that have different network architectures, have been trained differently and/or have been trained with different training data.

According to some implementations, the second speech classifier 1b comprises a speech separator configured to generate an output audio signal with isolated speech content that has been separated from an input audio signal. The speech separator may e.g. be based on a trained neural network. The audio signal is provided to the speech separator which predicts an output audio signal that comprises isolated speech with any background audio content being suppressed or removed completely. To determine a second speech confidence metric SM2 using the output audio signal, a ratio of the spectral energy of the output audio signal and the spectral energy of the input audio signal is determined and used as the second speech confidence metric SM2. The ratio may be determined for the entire signal meaning that a same second speech confidence metric SM2 is determined for all frames. Alternatively, the ratio is determined based on a fraction of the average spectral energies of the second context window or a fraction of the average spectral energies of each frame of the audio signal and output audio signal.

The spectral energy ratio may then be used directly as the second speech activity metric SM2.

The speech separator of the second speech classifier 1b may be the speech separator 20 used in the exemplary implementation described in connection with FIG. 1 or it may be a separate speech separator. Accordingly, in some implementations the output audio signal (that contains isolated speech) from the speech separator in the second speech classifier 1b is provided to the gating unit 10 which is controlled by the first binary speech classification indicator SB1 or enhanced binary speech classification indicator SBE. In some implementations, a second speech classifier 1b is not used or a second speech classifier 1b which does not use a speech separator is utilized whereby the speech separator 20 may be an external speech separator 20 which predicts a speech separated audio signal with isolated speech. In such implementations, the speech separated audio signal is provided to the gating unit 10 which is controlled by the first binary speech classification indicator SB1 or enhanced binary speech classification indicator SBE. Additionally, an external speech separator may be used even if the second speech classifier 1b comprises a speech classifier producing an output audio signal wherein the speech separated audio signal is provided to the gating unit and the output audio signal is used for determination of the second speech confidence metric SM2.

With further reference to the flow chart in FIG. 3 the incorporation of a second speech classifier 1b together with the first speech classifier 1a will now be described in detail. The input audio signal obtained at step S1 is also provided to the second speech classifier 1b which determines, for each frame of the input audio signal, a second speech confidence metric SM2 at step S7. The second speech confidence metric SM2, like the first speech confidence metric SM1, may be a value on the range [0, 1] or any other suitable range. Since the second speech classifier 1b is different from the first speech classifier 1a a frame-by-frame comparison of the first and second speech confidence metric SM1, SM2 will generally reveal that the first and second speech classification metric SM1, SM2 are different from each other. Of course, for some frames it may occur that the first and second speech classification metric SM1, SM2 are the same.

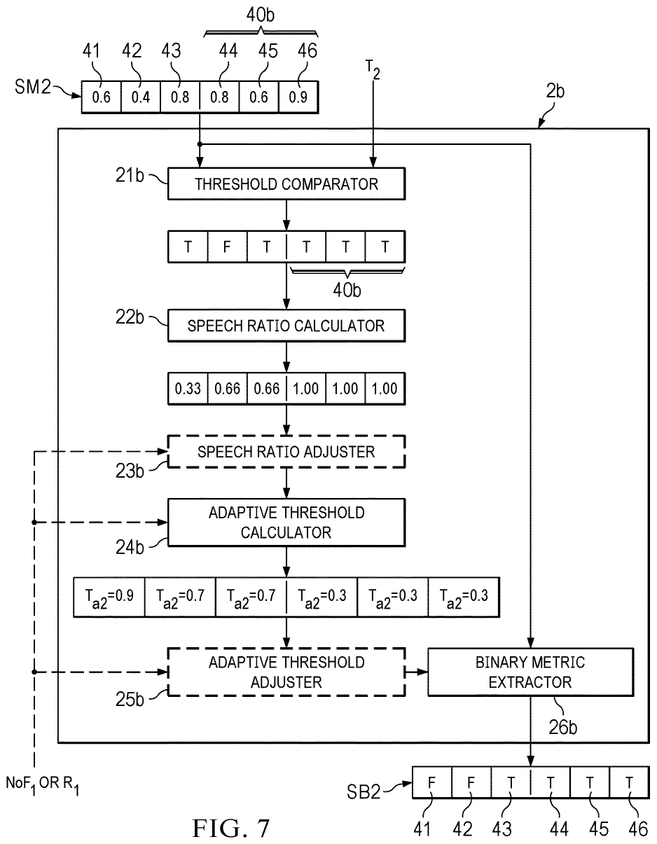

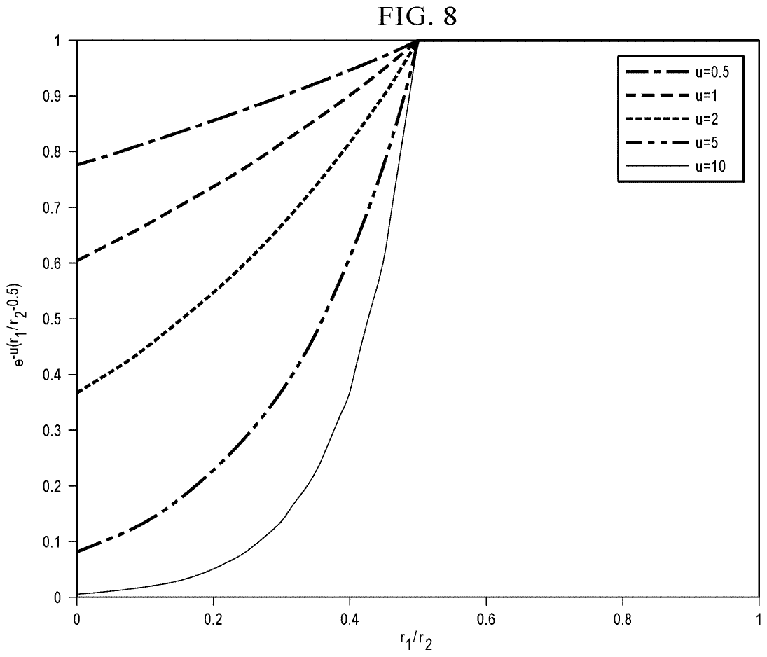

With further reference to FIG. 7, the second speech confidence metric SM2 is provided to a second adaptive threshold applicator 2b which at step S8, for each frame, binarizes the second speech confidence metric SM2 with a second threshold comparator 21b to classify each frame as a speech frame or non-speech frame. The second threshold comparator 21b uses a second predetermined threshold T₂ to establish, for each frame, if it is a speech frame or non-speech frame by binarizing the second speech confidence metric SM2 with the second predetermined threshold T₂. The second predetermined threshold T₂ may be equal to or different from the first predetermined threshold T₁, e.g. T₁ and T₂ are both equal to 0.5 or T₁ is equal to 0.5 and T₂ is lower and equal to 0.1 or 0.2. In some implementations, as described above, the second speech classifier 1b comprises a speech separator and determines the second speech confidence metric SM2 based on an energy ratio. In such implementations, it may be beneficial to set T₂ lower than T₁, e.g. such that T₁ is greater than 0.4 (e.g. equal to 0.5) and T₂ is smaller than 0.3 (e.g. equal to 0.2 or 0.1).

With a speech or non-speech label assigned to each frame based on the second speech confidence metric SM2, this information can be utilized in different ways to enhance the final speech classification accuracy of the speech classification system 10.

In one implementation, the second number of speech frames NoF₂ determined based the second speech confidence metric SM2 are counted by the speech ratio calculator 22b of the second adaptive threshold applicator 2b in a second context window 40b. The second context window 40b may be the same type of context window (i.e. in terms of number of look-ahead frames and/or look-back frames) or it may be different. In the example shown in FIG. 6 the second context window 40b has a total context window length of three. That is, when frame 45 is the given frame the second context window 40b includes look-back frame 44, the given frame 45 itself and one look-ahead frame 46. Again, in this illustrative example it is assumed that any frames preceding fame 41 are non-speech, F, frames and any frames succeeding frame 46 are speech, T, frames. Optionally, a second speech ratio r₂ is determined by the speech ratio calculator 22b as the fraction of number of speech frames NoF₂ to the length W₂ of the second context window 40b.

A second adaptive threshold Tₐ₂ is then determined at step S9 by a second adaptive threshold calculator 24b for each frame based on the number of speech frames NoF₂ in the second context window or the second speech ratio r₂. The second adaptive threshold level Tₐ₂ is provided to the second binary metric extractor 26b which at step S10 determines the second binary speech classification indicator SB2 by binarizing the second speech confidence metric SM2. The second adaptive threshold calculator 24b may determine the adaptive threshold using a threshold function. The threshold function implemented by the second adaptive threshold calculator 24b may be monotonically decreasing and e.g. similar or equal to one of threshold functions A-D of equations 1~4 above.

Accordingly, in this implementation the second adaptive threshold applicator 2b performs the corresponding functions as that of the first adaptive threshold applicator 2a described in detail in connection to FIG. 3 above with the difference being that the second adaptive threshold applicator 2b operates on the second speech confidence metric SM2 from the second classifier 1b.

The two speech classifiers 1a, 1b, with post-processing implemented by the first and second adaptive threshold applicator 2a, 2b outputs two binary speech classification indicators SB1, SB2 that may differ for one or more frames. For example, for a given frame the first binary speech classification indicator SB1 is true (T, indicating speech) and the second binary speech classification indicator SB2 is false (F, indicating non-speech). To combine the two binary speech classification indicators SB1, SB2 to form an enhanced binary speech classification indicator SBE, the two binary speech classification indicators SB1, SB2 may be provided to an enhanced binary speech extractor 3 which determines, at step S11 the enhanced binary speech classification indicator SBE as an “either-or” combination of SB1 and SB2, meaning that SBE will be true if at least one of SB1 and SB2 are true and false otherwise. Alternatively, the enhanced binary speech extractor 3 implements a strict “and” combination of SB1 and SB2, meaning that SBE will be true only if both SB1 and SB2 are true and false otherwise. The enhanced binary speech classification indicator SBE may be the final output of the speech classification system.

In the above described implementation, the two speech classifiers 1a, 1b and adaptive threshold applicators 2a, 2b operate independently of each other. However, for some implementations it has been realized that the benefits of using two classifiers are better leveraged by allowing the adaptive threshold applicators 2a, 2b to exchange information.

In one implementation, the first number of speech frames NoF₁ or first speech ratio r₁ determined by the first adaptive threshold applicator 2a is sent to the second adaptive threshold applicator 2b and used to control the second adaptive threshold applicator 2b. This may entail that the second adaptive threshold applicator 2b does not need a threshold comparator 21b or speech ratio calculator 22b as the first number of speech frames NoF₁ or first speech ratio r₁ is provided by the first speech applicator to replace the second number of speech frames NoF₂ or second speech ratio r₂. The adaptive threshold calculator 24b may then determine the adaptive threshold using a threshold function. For example, threshold function f_{E}(r) defined as

$${g}_{E} ( r ) = 0.5 + 6 ( 0.2 - r 1 ) \qquad ( eq . 5 )$$

$${f}_{E} ( r ) = max ( {g}_{E} ( r 1 ) , 0.1 )$$

is used, but many other types of thresholds function can be used instead.

The opposite arrangement, i.e. the second adaptive threshold applicator determining the second number of frames NoF₂ or second speech ratio r₂ and providing this information to the first adaptive threshold applicator 2a to control the first adaptive threshold calculator 2a is also envisaged.

In general, the above described examples work well for both music content and movie/sports content. The two classifiers 1a, 1b operate in parallel, with their respective binary speech classification metrics SB1, SB2 being combined by the final binary speech extractor 3. Optionally, the NoF₁ or r₁ of the first classifier is provided to the second classifier or vice versa.

For some complex content types, the agreement between the first classifier 1a and second classifier 1b may reveal further useful information that can be used to determine a more accurate adaptive threshold. For example, the parameters of the adaptive threshold function implemented by each adaptive threshold applicator 2a, 2b may be controlled based on the relationship between NoF₁/r₁ and NoF₂/r₂. Additionally or alternatively, the initially determined NoF₁/r₁ and NoF₂/r₂ (and/or the initially determined first and second adaptive threshold) may be modified, e.g. increased or decreased, based on the consistency between NoF₁/r₁ and NoF₂/r₂. The modified NoF₁/r₁ and NoF₂/r₂ (and/or the modified first and second adaptive threshold) may then be used as replacement for the initially determined NoF₁/r₁ and NoF₂/r₂ (and/or the first and second adaptive threshold). The exact way in which the adaptive threshold functions are controlled is based on the types of classifiers 1a, 1b used. For example, if one classifier is more accurate for detecting speech its speech confidence metric should influence the final binary speech classification more compared to the speech confidence metric of the other classifier when NoF₁/r₁ or NoF₂/r₂ is low.

In some implementations there are four main cases to consider for different relationships between NoF₁/r₁ and NoF₂/r₂. These cases will now be exemplified for a setup wherein the first classifier 1a exhibits a high false negative rate (i.e. makes conservative classification with tendencies to miss some speech) wherein the second classifier 1b exhibits a high false positive rate (i.e. makes exaggerated classification with tendencies to classify some non-speech as speech). Other classifiers, with other characteristics, may benefit from similar or different interplay between NoF₁/r₁ and NoF₂/r₂.

In case one, NoF₁/r₁ is low and NoF₂/r₂ is high. In this case, first classifier 1a does not detect as much speech compared to the second classifier 1b. With the second speech classifier 1b of the present example, this often happens for music content. The adaptive threshold for the second adaptive threshold applicator 2b for this case is configured to increase for decreasing NoF₁/r₁. As seen in FIG. 7, this may be accomplished by providing NoF₁/r₁ to the optional speech ratio adjuster 23b, wherein the speech ratio adjuster 23b adjusts the NoF₂/r₂ such that NoF₂/r₂ decreases yielding an increase in adaptive threshold in the subsequent adaptive threshold calculator 24b. Additionally or alternatively, NoF₁/r₁ is provided to the optional adaptive threshold adjuster 25b which increases the adaptive thresholds output by the adaptive threshold calculator 24b.

This adjustment may have the effect that the false positives caused by the second classifier 1b will be avoided since the second adaptive threshold Tₐ₂ increases, causing fewer frames to be labeled as speech frames. With the terms “high” and “low” it is meant that NoF₁ or r₁ is above or below a first case threshold and the same applies analogously to NoF₂ or r₂ being high or low when it is above or below a second case threshold.

In case two, NoF₁/r₁ is high and NoF₂/r₂ is high. This means that both classifiers 1a, 1b have identified much speech and that the first classifier 1a likely does not have many false negatives. In this case, the second classifier 1b will only be considered if the second classifier has very high confidence. Accordingly, the second adaptive threshold is increased (using either the speech ratio adjuster 23b or adaptive threshold adjuster 24b) for higher NoF₁/r₁ to avoid the second classifier 1b introducing false positives.

In case three, NoF₁/r₁ is high and NoF₂/r₂ is low. This case rarely happens in the exemplified setup. However, since the first speech classifier 1a has identified much speech there is likely a low rate of false negatives. The same approach as in case two is applied in case three, with the second adaptive threshold being increased for higher NoF₁/r₁ to avoid the second classifier 1b introducing false positives.

In case four, NoF₁/r₁ is low and NoF₂/r₂ is low. In this case, both classifiers 1a, 1b have low, but not zero, number of speech frames or speech ratio. This is likely caused by audio content with sparse speech rather than music content or content that puts a strain on both classifiers at the same time. In this case, the adaptive threshold of the second adaptive threshold applicator 2b is decreased with decreasing NoF₁/r₁. This allows the second adaptive threshold applicator 2b to identify more speech if it is in agreement with the first classifier 1a and thus incorporate more speech frames identified by the second classifier 1b. However, some tests have found that case four may also occur for some types of music meaning that in some implementations case four is not used and only cases one through three are used.

The above four cases apply to four types of audio content that fulfill the requirements listed above (i.e. the NoF₁/r₁ and NoF₂/r₂ being above or below a respective case threshold). In some implementations, it is determined which out of the four cases is valid for each frame and the adaptive threshold functions are modified accordingly, e.g. by an additive or multiplicative adjustment term or factor introduced by the speech ratio adjuster 23b or adaptive threshold adjuster 24b. It is also envisaged that the parameters of the adaptive threshold functions implemented in each of the adaptive threshold applicators 2a, 2b are dynamically tuned or that the functions are swapped depending on which out of the four cases that holds for a current frame.

Additionally, while cases one through four above relate to modification of the second NoF₂/r₂ of the second adaptive threshold applicator 2b based on the NoF₁/r₁ of the first adaptive threshold applicator 2a the opposite is also possible, i.e. modification of the first NoF₁/r₁ of the first adaptive threshold applicator 2a based on the NoF₂/r₂ of the second adaptive threshold applicator 2b. For example, in case one where NoF₁/r₁ is low and NoF₂/r₂ is high, indicating e.g. music content with singing voice, NoF₁/r₁ is decreased based on the difference between NoF₁/r₁ and NoF₂/r₂. As the difference between NoF₁/r and NoF₂/r₂ increases NoF₁/riis decreased. In general, the first adaptive threshold is increased for decreasing NoF₁/r₁ meaning that this helps to achieve a higher first adaptive threshold to further avoid false positives. Alternatively, the first adaptive threshold is increased directly based on the difference between NoF₁/r₁ and NoF₂/r₂, such that the first adaptive threshold is increased as the difference between NoF₁/r₁ and NoF₂/r₂ increases. For example, in case one, NoF₁/r₁ is decreased and/or the first adaptive threshold is increased only when NoF₁/r₁ and NoF₂/r₂ are sufficiently inconsistent (i.e. having a sufficiently large difference).

In case two, the classifiers 1a, 1b detect high NoF₁/r₁ and high NoF₂/r₂, respectively, which may indicate movie content or some other speech-heavy content. In this case, NoF₁/r₁ is increased, and/or the first adaptive threshold is decreased, based on the difference between the detected NoF₁/r₁ and detected NoF₂/r₂. As the difference between NoF₁/r₁ and NoF₂/r₂ decreases NoF₁/r is increased and/or the first adaptive threshold is decreased. For example, in case two, the NoF₁/r is increased, and/or the first adaptive threshold is decreased, only when NoF₁/r₁ and NoF₂/r₂ are sufficiently consistent (i.e. having a sufficiently small difference).

In case three, the first adaptive threshold can be kept as is without impact from NoF₂/r₂. In case four both classifiers 1a, 1b have low number of speech frames or speech ratios. This may be the result of audio content with sparse speech or challenging audio content that strains both classifiers 1a, 1b (rather than music which would trigger the second classifier 1b to detect speech). In case four, the first adaptive threshold is decreased and/or NoF₁/r₁ is increased to incorporate more speech frames identified by the first classifier 1a.

It is also possible that both types of modifications, i.e. modification of NoF₁/r₁ based on NoF₂/r₂ and modification NoF₂/r₂ based on NoF₁/r₁ are implemented simultaneously.

In some implementations, the first speech ratio r₁ and second speech ratio r₂ are used by the first adaptive threshold applicator to form a modified speech ratio r′, that replaces the first speech ratio r₁. The modified speech ratio r′ may e.g. be determined using the equation:

$${r}^{′} = {r}_{1} {e}^{- u ( {r}_{1} / {r}_{2} - 0.5 )} if {r}_{1} < {r}_{2} / 2 \qquad ( eq . 6 )$$

with u being a parameter controlling the aggressiveness of the exponential scaling factor. In a similar fashion, a modified number of frames, MNoF, can also be determined, e.g. by using equation 6 and replacing r′ with MNOF, r₁ with NoF₁, and r₂ with NoF₂*(W₂/W₁) wherein W₁ and W₂ are the window lengths in number of frames.

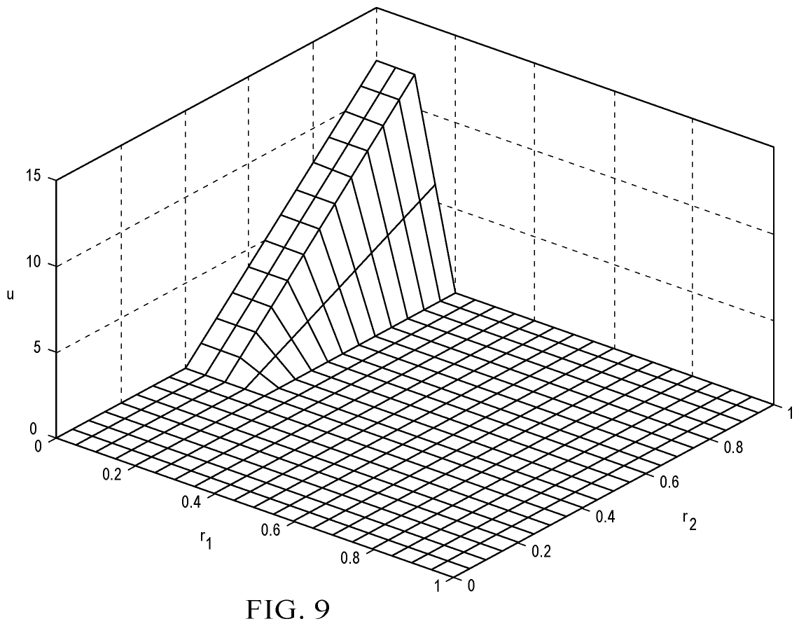

The parameter u determines the steepness of the exponential scaling factor that modifies the scaling of r₁ or NoF₁ to form r′ or MNoF. In FIG. 8 the value of the exponential scaling factor is shown as a function of the ratio r₁/r₂ for different values of the parameter u. The scaling factor u is also adjusted based on the ratio r₁/r₂ and r₁. In some implementations, the scaling factor u is set according to the function shown in FIG. 9 with higher values of u being assigned when r₂ exceeds 0.4 and r₁ is less than 0.2. With this type of function, the u parameter becomes larger when r₁ is smaller than r₂ which reduces the modified speech ratio to bring about a more conservative speech classification. Especially, when the second classifier 1b is embodied with a speech separator this configuration of u has shown to reduce the false positive rates for music by correctly labeling signing voice as non-speech.

Since the number of speech frames NoF₁, NoF₂ or speech ratio r₁, r₂ of either adaptive threshold applicator 2a, 2b can be sent to the other adaptive threshold applicator 2a, 2b it is envisaged that only one of the first and second binary speech classification indicator SB1, SB2 is determined as the final binary classification of the speech classification system 10. To this end, the final binary speech extractor 3 may be omitted in some implementations wherein the one of the adaptive threshold calculators 1a, 1b outputs a number of speech frames or a speech ratio which is provided to the other adaptive threshold calculators 1a, 1b that determines the adaptive threshold for making the final binarization based on both NoF₁ and NoF₂ or based on both r₁ and r₂. For example, the first adaptive threshold applicator 2a determines a modified MNoF or r′ value using equation 6 above or implements an extended threshold function f(NoF₁, NoF₂), f(r₁, r₂) that maps each combination of NoF₁ and NoF₂, or r₁ and r₂, to an adaptive threshold.

Unless specifically stated otherwise, as apparent from the following discussions, it is appreciated that throughout the disclosure discussions utilizing terms such as “processing”, “computing”, “calculating”, “determining”, “analyzing” or the like, refer to the action and/or processes of a computer hardware or computing system, or similar electronic computing devices, that manipulate and/or transform data represented as physical, such as electronic, quantities into other data similarly represented as physical quantities.

It should be appreciated that in the above description of exemplary embodiments of the disclosure, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure. Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with instructions for carrying out such a method or element of a method forms a means for carrying out the method or element of a method. Note that when the method includes several elements, e.g., several steps, no ordering of such elements is implied, unless specifically stated. Furthermore, an element described herein of an apparatus embodiment is an example of a means for carrying out the function performed by the element for the purpose of carrying out the embodiments of the disclosure. In the description provided herein, numerous specific details are set forth. However, it is understood that embodiments of the disclosure may be practiced without these specific details. In other instances, well-known methods, structures and techniques have not been shown in detail in order not to obscure an understanding of this description. Thus, while there has been described specific embodiments of the disclosure, those skilled in the art will recognize that other and further modifications may be made thereto without departing from the spirit of the disclosure, and it is intended to claim all such changes and modifications as falling within the scope of the disclosure.

Various aspects of the present disclosure may be appreciated from the following Enumerated Example Embodiments (EEEs):
EEE1. A method for performing speech classification for an audio signal comprising:
   obtaining the audio signal comprising a sequence of audio frames;
   determining, for each audio frame, a first speech confidence metric using a first speech classifier, the first speech confidence metric indicating a likelihood of speech being present in the audio frame;
   for each given audio frame of at least a subset of the sequence of audio frames:
      classifying each respective audio frame of a first context window associated with the given audio frame as a speech frame or non-speech frame by comparing the first speech confidence metric of the respective audio frame to a first predetermined threshold;
      determining an adaptive threshold based on a number of speech frames of the first context window; and
      determining a first binary speech classification indicator for the given audio frame based on the first speech confidence metric and the adaptive threshold.
EEE2. The method according to EEE1, wherein the adaptive threshold is determined using a function mapping the number of speech frames in the first context window to an adaptive threshold
EEE3. The method according to EEE2, wherein the function is monotonically decreasing for increasing number of speech frames in the first context window.
EEE4. The method according to any one of the preceding EEEs, wherein determining the first binary speech classification indicator comprises binarizing the first speech confidence metric with the adaptive threshold.
EEE5. The method according to any one of EEE1-EEE3, further comprising:
   determining, for each audio frame, a second speech confidence metric using a second speech classifier different from the first speech classifier, the second speech confidence metric indicating a likelihood of speech being present in the frame;
   for each given audio frame of the subset of the sequence of audio frames:
      classifying each respective audio frame of a second context window associated with the given audio frame as a speech frame or non-speech frame by comparing the second speech confidence metric of the respective frame to a second predetermined threshold;
      determining a second adaptive threshold based on a number of speech frames in the second context window and/or the number of speech frames in the first context window, and determining an enhanced binary speech classification indicator for the given audio frame based on the adaptive threshold and the second adaptive threshold, and/or
      wherein the adaptive threshold is based on the number of speech frames in the first context window and the number of speech frames in the second context window.
EEE6. The method according to EEE5, wherein the second speech classifier comprises a speech separator configured to generate an output audio signal with isolated speech content separated from an input audio signal, the method further comprising:
   processing the audio signal with the speech separator to obtain the output audio signal with isolated speech content; and
   determining the second speech confidence metric based on a spectral energy ratio of a spectral energy metric for the output audio signal and a spectral energy metric for the audio signal.
EEE7. The method according to EEE6, wherein the spectral energy ratio is determined as the ratio between:
   an average spectral energy metric of the output audio signal across all frames of the audio signal, across all frames of the second context window, or individually for each frame, and
   the average spectral energy metric of the audio signal across all frames of the audio signal, across all frames of the second context window, or individually for each frame.
EEE8. The method according to any one of EEE5-EEE7, wherein the adaptive threshold is based on the number of speech frames in the first context window and the number of speech frames in the second context window, the method further comprising:
   determining the first binary speech classification indicator by binarizing the first speech confidence metric using the adaptive threshold.
EEE9. The method according to EEE8, wherein determining the adaptive threshold based on the number of speech frames in the first context window and the number of speech frames in the second context window comprises:
   obtaining an extended function linking a number of speech frames in the first context window and a number of speech frames in the second context window to a variable threshold; and
   evaluating the extended function with the number of speech frames in the first context window and the number of speech frames in the second context window.
EEE10. The method according to EEE9, wherein the extended function is based on only the number of speech frames in the first context window when the number of speech frames in the first context window is above a first predetermined number and the number of speech frames in the second context window is below a second predetermined number, and
wherein the extended threshold function is based on both the number of speech frames in the first context window and the number of speech frames in the second context window when the number of speech frames in the first context window is below or equal to the first predetermined number and the number of speech frames in the second context window is above or equal to the second predetermined number.
EEE11. The method according to any one of EEE5-EEE10, further comprising:
   for each given audio frame of the subset of the sequence of audio frames:
   determining a second adaptive threshold based on the number of speech frames in the second context window and/or the number of speech frames in the first context window;
   determining the first binary speech classification indicator by binarizing the first speech confidence metric of the given audio frame using a first variable threshold;
   determining a second binary speech classification indicator by binarizing the second speech confidence metric of the given audio frame using a second variable threshold; and
   determining the enhanced binary speech classification indicator based on the first binary speech classification indicator and the second binary speech classification indicator.
EEE12. The method according to EEE11, wherein the enhanced binary speech classification indicator indicates that speech is active only if at least one of the first binary speech classification indicator and the second binary speech classification indicator indicates that speech is active.
EEE13. The method according to any one of EEE1-EEE4, further comprising:
   providing the first binary speech classification indicator and the audio signal to a gating unit; and
   applying, by the gating unit, a gating gain to the audio signal based on the first binary speech classification indicator to form a gated audio signal.
EEE14. The method according to any one of EEE5-EEE12, further comprising:
   providing the enhanced binary speech classification indicator and the audio signal to a gating unit; and
   applying, by the gating unit, a gating gain to the audio signal based on the enhanced binary speech classification indicator to form a gated audio signal.
EEE15. The method according to EEE13 or EEE14, further comprising:
   processing the audio signal with a speech separator to obtain a speech separated audio signal with isolated speech content; and
   applying, by the gating unit, the gating gain to the speech separated audio signal.
EEE16. The method according to any one of the preceding EEEs, wherein the first context window associated with the given audio frame comprises the given audio frame.
EEE17. The method according to EEE16, wherein the first context window comprises at least one look-ahead frame succeeding the given audio frame in time and at least one look-back frame preceding the given audio frame in time.
EEE18. The method according to any one of the preceding EEEs, wherein a temporal duration of the first or second context window is at least 5 seconds, at least 10 seconds, at least 20 seconds or at least 30 seconds.
EEE19. The method according to any one of the preceding EEEs, wherein the first predetermined threshold is between 0.1 and 0.6, such as about 0.5 or about 0.3.
EEE20. A computer program product comprising instructions which, when the program is executed by a computer, causes the computer to carry out the method according to any one of EEE1-EEE19.
EEE21. A computer-readable storage medium storing the computer program according to EEE20.
EEE22. A system comprising one or more processors configured to carry out the method according to any one of EEE1-EEE19.

1. A method for performing speech classification for an audio signal comprising:
obtaining the audio signal comprising a sequence of audio frames;
determining, for each audio frame, a first speech confidence metric using a first speech classifier, the first speech confidence metric indicating a likelihood of speech being present in the audio frame;
for each given audio frame of at least a subset of the sequence of audio frames:
classifying each respective audio frame of a first context window associated with the given audio frame as a speech frame or non-speech frame by comparing the first speech confidence metric of the respective audio frame to a first predetermined threshold;
determining an adaptive threshold based on a number of speech frames of the first context window; and
determining a first binary speech classification indicator for the given audio frame based on the first speech confidence metric and the adaptive threshold.

2. The method according to claim 1, wherein the adaptive threshold is determined using a function mapping the number of speech frames in the first context window to an adaptive threshold.

3. The method according to claim 2, wherein the function is monotonically decreasing for increasing number of speech frames in the first context window.

4. The method according to claim 1, wherein determining the first binary speech classification indicator comprises binarizing the first speech confidence metric with the adaptive threshold.

5. The method according to claim 1, further comprising:
determining, for each audio frame, a second speech confidence metric using a second speech classifier different from the first speech classifier, the second speech confidence metric indicating a likelihood of speech being present in the frame;
for each given audio frame of the subset of the sequence of audio frames:
classifying each respective audio frame of a second context window associated with the given audio frame as a speech frame or non-speech frame by comparing the second speech confidence metric of the respective frame to a second predetermined threshold;
determining a second adaptive threshold based on a number of speech frames in the second context window and/or the number of speech frames in the first context window, and determining an enhanced binary speech classification indicator for the given audio frame based on the adaptive threshold and the second adaptive threshold, and/or
wherein the adaptive threshold is based on the number of speech frames in the first context window and the number of speech frames in the second context window.

6. The method according to claim 5, wherein the second speech classifier comprises a speech separator configured to generate an output audio signal with isolated speech content separated from an input audio signal, the method further comprising:
processing the audio signal with the speech separator to obtain the output audio signal with isolated speech content; and
determining the second speech confidence metric based on a spectral energy ratio of a spectral energy metric for the output audio signal and a spectral energy metric for the audio signal.

7. The method according to claim 6, wherein the spectral energy ratio is determined as the ratio between:
an average spectral energy metric of the output audio signal across all frames of the audio signal, across all frames of the second context window, or individually for each frame, and
the average spectral energy metric of the audio signal across all frames of the audio signal, across all frames of the second context window, or individually for each frame.

8. The method according to claim 5, wherein the adaptive threshold is based on the number of speech frames in the first context window and the number of speech frames in the second context window, the method further comprising:
determining the first binary speech classification indicator by binarizing the first speech confidence metric using the adaptive threshold.

9. The method according to claim 8, wherein determining the adaptive threshold based on the number of speech frames in the first context window and the number of speech frames in the second context window comprises:
obtaining an extended function linking a number of speech frames in the first context window and a number of speech frames in the second context window to a variable threshold; and
evaluating the extended function with the number of speech frames in the first context window and the number of speech frames in the second context window.

10. The method according to claim 9, wherein the extended function is based on only the number of speech frames in the first context window when the number of speech frames in the first context window is above a first predetermined number and the number of speech frames in the second context window is below a second predetermined number, and
wherein the extended threshold function is based on both the number of speech frames in the first context window and the number of speech frames in the second context window when the number of speech frames in the first context window is below or equal to the first predetermined number and the number of speech frames in the second context window is above or equal to the second predetermined number.

11. The method according to claim 5, further comprising:
for each given audio frame of the subset of the sequence of audio frames:
determining a second adaptive threshold based on the number of speech frames in the second context window and/or the number of speech frames in the first context window;
determining the first binary speech classification indicator by binarizing the first speech confidence metric of the given audio frame using a first variable threshold;
determining a second binary speech classification indicator by binarizing the second speech confidence metric of the given audio frame using a second variable threshold; and
determining the enhanced binary speech classification indicator based on the first binary speech classification indicator and the second binary speech classification indicator.

12. The method according to claim 11, wherein the enhanced binary speech classification indicator indicates that speech is active only if at least one of the first binary speech classification indicator and the second binary speech classification indicator indicates that speech is active.

13. The method according to claim 1, further comprising:
providing the first binary speech classification indicator and the audio signal to a gating unit; and
applying, by the gating unit, a gating gain to the audio signal based on the first binary speech classification indicator to form a gated audio signal.

14. The method according to claim 5, further comprising:
providing the enhanced binary speech classification indicator and the audio signal to a gating unit; and
applying, by the gating unit, a gating gain to the audio signal based on the enhanced binary speech classification indicator to form a gated audio signal.

15. The method according to claim 13, further comprising:
processing the audio signal with a speech separator to obtain a speech separated audio signal with isolated speech content; and
applying, by the gating unit, the gating gain to the speech separated audio signal.

16. The method according to claim 1, wherein the first context window associated with the given audio frame comprises the given audio frame.

17. The method according to claim 16, wherein the first context window comprises at least one look-ahead frame succeeding the given audio frame in time and at least one look-back frame preceding the given audio frame in time.

18. The method according to claim 1, wherein a temporal duration of the first or second context window is at least 5 seconds, at least 10 seconds, at least 20 seconds or at least 30 seconds.

19. The method according to claim 1, wherein the first predetermined threshold is between 0.1 and 0.6, such as about 0.5 or about 0.3.

20. A computer program product comprising instructions which, when the program is executed by a computer, causes the computer to carry out the method according to claim 1.

21. (canceled)

22. (canceled)
